(19) United States
(12) Patent Application Publication
(10) Pub. No.: US 2004/0205481 A1
(43) Pub. Date: Oct. 14, 2004

(54) Multimedia delivery methods and multifunction device therefor

(76) Inventors: Oscar A. Zuniga, Fort Collins, CO (US); Jeffrey S. Tiffan, Greeley, CO (US); Jeffrey G. Wiley, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/024,422

(22) Filed: Dec. 17, 2001

(51) Int. Cl. G06F 17/24

(52) U.S. Cl. 715/500.1; 715/523

(57) ABSTRACT

Multimedia delivery methods and multifunction device therefor. Embodiments of the multifunction device may comprise first and second transducers for formatting first and second presentation media, respectively, and computer readable media operatively associated with the multifunction device and having computer readable program code thereon. The computer readable program code may include program code for generating a multimedia presentation from the first and second presentation media for delivery thereof to a network destination from the multifunction device. The computer readable program code may also include program code for separating the multimedia presentation into first and second presentation media for delivery thereof to a user at the multifunction device.

### FIELD OF THE INVENTION

The invention generally pertains to multifunction devices, and more specifically, to methods for multimedia delivery and multifunction devices therefor.

### BACKGROUND OF THE INVENTION

Multifunction devices (MFDs) offer a convenient way of communicating with a variety of devices from an individual stand-alone device. Briefly, multifunction devices may be used to convert a paper document to an electronic image and then to transmit the electronic image to a variety of network destinations. For example, the multifunction device may be used to send the electronic image of the paper document to an email account, a fax machine, a printer, a copier, a mobile phone, and an Internet or other network site, to name but a few such network destinations.

As an illustration, the user may send a paper document to one or more recipients as follows. The user positions a paper document in the automatic document feeder (ADF) or directly on the imaging bed of the multifunction device. The user then activates the multifunction device, for example, by pressing a “start” button. In turn, the multifunction device converts the paper document to an electronic image thereof. The user may identify the recipient(s) for the electronic image of the paper document. For example, the user may identify the recipient(s) by keying in a fax number, an email account, etc., using the keypad of the multifunction device. Or for example, the user may identify the recipient(s) by selecting the same from a menu or address book shown on the display at the multifunction device. The multifunction device then sends the electronic image of the paper document over a suitable network (e.g., the Internet, an Intranet) to the recipient(s) at any of a number of various network destinations.

In various circumstances, the user may want to communicate with the recipient(s) beyond simply sending the recipient(s) a document by itself. Such circumstances may present themselves, for example, when the user desires to include a personal greeting for the recipient(s), a request for the user's immediate attention, or further instructions for the recipient(s) (e.g., “please review”). The need to further communicate with the recipient(s) is especially apparent when the document is not self-explanatory (e.g., a spreadsheet with mostly numbers). In such a circumstance, the user may want to explain the purpose of the document that he or she is sending to the recipient(s) (e.g., “this quarter's profits are strong, as evidenced by the attached spreadsheet”).

The user may so communicate with the recipient(s) by writing on the document itself. Likewise, the user may annotate each page of a document by writing on each page thereof. However, often it is important that the recipient(s) receive a “clean” copy of the document (i.e., without any “extra” writing thereon). Accordingly, the user must instead write on a coversheet to be included with the document. Alternatively, the user may attach an electronic coversheet to the document using a keyboard or a keypad provided with the multifunction device. Oftentimes, however, multimedia presentations (e.g., a voice describing the document) are more effective for communicating with the recipient.

Multifunction devices suffer from the disadvantage that they are unable to send and receive multimedia presentations. Although the user may send the document to the recipient(s) using the multifunction device, and then call the recipient(s) to discuss the document, the recipient(s) may not be near a telephone. Indeed, when the document is being sent to a fax machine or to an email account, the recipient(s) may not actually receive the document for some time after it has been sent. Accordingly, attempts to reach the recipient(s) by telephone may be futile. In addition, when there is more than one recipient, the user must call each of the recipients to discuss the document.

### SUMMARY OF THE INVENTION

Multifunction device for delivering a multimedia presentation may comprise a first transducer for formatting a first presentation media, a second transducer for formatting a second presentation media, and computer readable media operatively associated with the multifunction device and having computer readable program code thereon. The computer readable program code may include program code for generating a multimedia presentation from the presentation media for delivery thereof to a network destination from the multifunction device, and program code for separating the multimedia presentation into a first presentation media and a second presentation media for delivery thereof to a user at the multifunction device.

### BRIEF DESCRIPTION OF THE DRAWINGS

Illustrative and presently preferred embodiments of the invention are illustrated in the drawings, in which:

FIG. 1 is a high-level diagram illustrating a multifunction device for delivering a multimedia presentation according to embodiments of the invention;

FIG. 2 is a detailed view of a portion of the multifunction device for delivering a multimedia presentation showing an embodiment of an interface of the multifunction device;

FIG. 3 illustrates an embodiment of a method for delivering a multimedia presentation; and

FIG. 4 illustrates another embodiment of a method for delivering a multimedia presentation.

### DETAILED DESCRIPTION

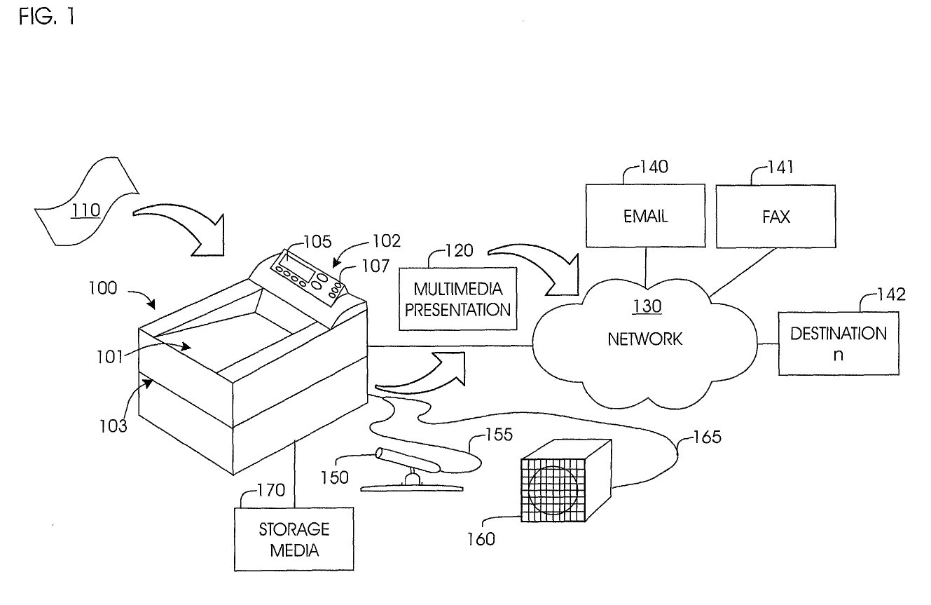

Multifunction device 100 (FIG. 1) is shown and described herein as it may be used to deliver a multimedia presentation according to embodiments of the invention. Briefly, multifunction devices 100 are a convenient means for sending documents 110 to one or more recipients at any of a number of different types of devices 140-142 (e.g., a fax machine, an email account, etc.). As an illustration, the user may position a paper document 110 in the automatic document feeder (ADF) 101 or directly on the imaging bed 103 of the multifunction device 100, identify the recipient(s) for the document, and activate the multifunction device 100. In turn, the multifunction device 100 converts the paper document 110 to an electronic image thereof (e.g., electronic document 120), and sends the electronic document 120 over a suitable network (e.g., the Internet, an Intranet, a telephone network, a wide-area network (WAN), to name a few) to the recipient(s) at any number of the different types of devices.

The user may want to communicate with the recipient(s) beyond just sending the document 110 by itself to the recipient(s). For example, the user may want to send a personal greeting, request the user's immediate attention, or explain a document 110 (e.g., a spreadsheet) that is not self-explanatory. In some circumstances, the user may even desire to annotate one or more pages of a document 110 (e.g., to draw the recipient's attention to specific text on various pages in the document). However, such supplemental communication typically requires the user to either add notes to the document 110 itself, include a cover sheet with the document 110, or separately contact the recipient(s) (e.g., via telephone). In some circumstances, a multimedia presentation (e.g., a voice describing the document) may be more effective for communicating with the recipient(s). However, multifunction devices 100 are conventionally limited to the delivery of one form of media (i.e., documents).

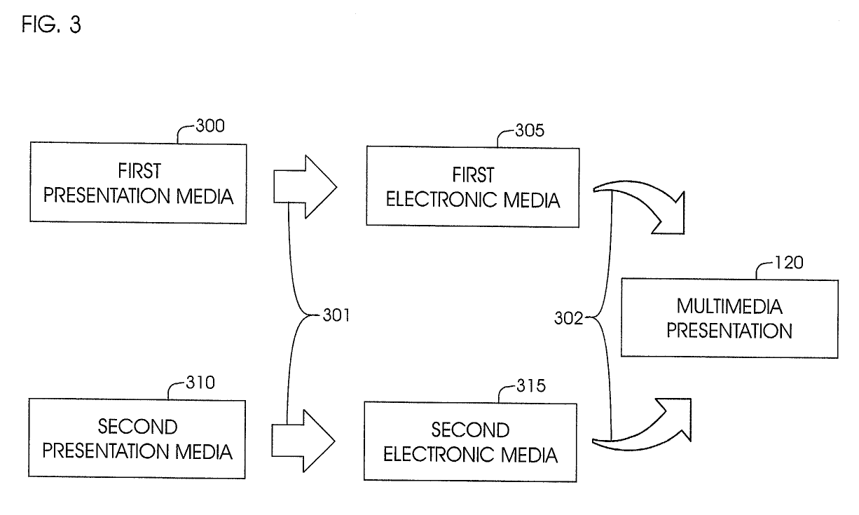

According to the teachings of the invention, a multifunction device 100 (FIG. 1) may be provided for delivering a multimedia presentation 120 to the recipient(s) at any number of different types of devices, including, but not limited to another multifunction device. The multimedia device 100 may comprise a first transducer 150 for formatting a first presentation media 300 (FIG. 3), and a second transducer 101, 103 for formatting a second presentation media 310 (FIG. 3). In addition, the multifunction device 100 may comprise computer readable media 170 operatively associated therewith and having computer readable program code thereon. The computer readable media may comprise one or more of any suitable media, as explained in more detail below. Likewise, the computer readable program code may reside on the computer readable media in any suitable manner, also as explained in more detail below. The computer readable program code may include program code for generating a multimedia presentation 120 from the first and second presentation media 300, 310 for delivery thereof to a network destination 140-142 from the multifunction device 100, and program code for separating the multimedia presentation 120 into a first presentation media 300 and a second presentation media 310 for delivery thereof to a user at the multifunction device 100.

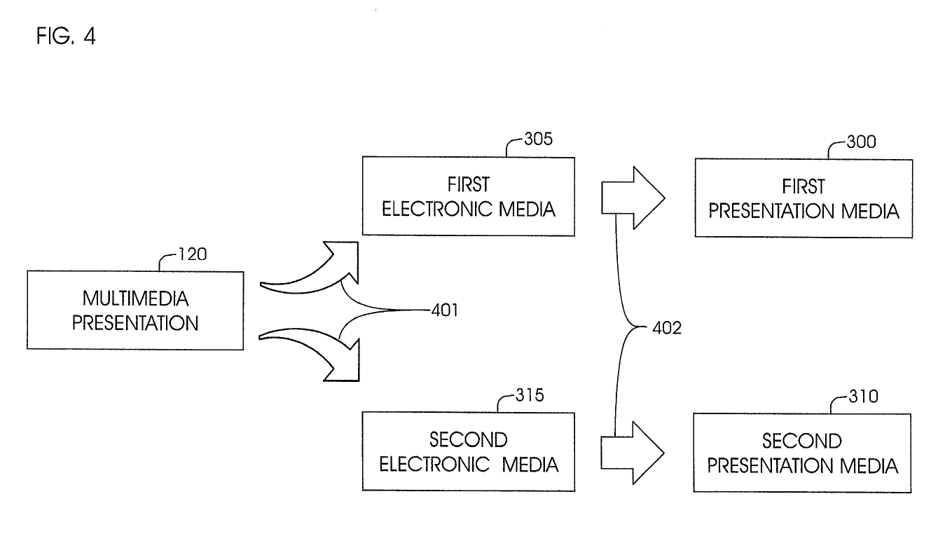

The multifunction device 100 (FIG. 1) may be operated as follows for delivering a multimedia presentation 120. A first presentation media 300 (FIG. 3) and a second presentation media 310 (FIG. 3) are preferably each received in electronic format at a multifunction device 100. For example, the user may scan a paper document 110 at the multifunction device 100 and speak into a microphone 150 to provide a voice explanation of thereof. The first and second presentation media 300, 310 may then be used to generate the multimedia presentation 120 for delivery thereof to a network destination 140-142 from the multifunction device 100. In addition, the user may receive a multimedia presentation 120 at the multifunction device 100, as shown in FIG. 4. The multimedia presentation 120 may be separated into a first presentation media 300 and a second presentation media 310 for delivery thereof to a user at the multifunction device 100. For example, a paper document 110 may be printed for the user at the multifunction device 100 itself (i.e., if it has printing capability) or at a printer linked thereto, and a voice explanation thereof may be played for the user through a speaker 160.

Accordingly, the user may more effectively communicate with the recipient(s) using multimedia presentations delivered from the multifunction device 100. For example, the user may annotate each page of a document with spoken explanations, without having to write notes on the document 110, or without having to separately contact the recipient(s) by telephone or otherwise.

Having generally described multimedia delivery methods and multifunction device therefor, as well as some of its more significant features and advantages, the various embodiments of the invention will now be described in further detail.

A multifunction device 100 for delivering a multimedia presentation 120 may be linked over a suitable network 130 to a number of network destinations 140-142, as shown in FIG. 1. More specifically, the multifunction device 100 may comprise a number of transducers for formatting various presentation media (e.g., 300, 310 in FIG. 3 and FIG. 4). According to preferred embodiments of the invention, the multifunction device 100 may comprise a first transducer, such as a microphone 150 and/or a speaker 160 operatively associated therewith (e.g., by links 155, 165, respectively) for recording and/or playing audible sound. In addition, the multifunction device 100 may also comprise a second transducer, such as an imaging component (e.g., broadly illustrated by imaging bed 103 and/or ADF 101) operatively associated therewith for scanning “paper” documents 110. Likewise, the second transducer may comprise a printing component (e.g., an attached or integrated printer) for printing “paper” documents 110. Also according to preferred embodiments of the invention, the multifunction device 100 may comprise an interface 102 (e.g., a display 105 and a keypad 107) operatively associated therewith, that the user may make use of for interacting with the multifunction device 100.

Also according to preferred embodiments of the invention, computer readable media 170 may be operatively associated with the multifunction device 100 having computer readable program code thereon for delivering the multimedia presentation 120. The computer readable media may comprise any suitable media that is now known or is later developed. For example, the computer readable media may comprise media such as attached storage (e.g., a hard disk drive), random access memory (RAM), removable media (e.g., a compact disc (CD)), etc., and is not necessarily limited to media of the multifunction device 100 itself. In addition, it is understood that the computer readable program code may comprise a software application, an executable file (e.g., an applet), routines, subroutines, etc. Indeed, the computer readable program code may access other computer readable program code for performing one or more tasks. In addition, the computer readable program code may be stored in whole on a single computer readable medium, or various components of the computer readable program code may be stored on more than one computer readable media. Preferred embodiments of the computer readable program code are explained in more detail below.

Before continuing, the following definitions are provided to further describe the invention. The terms “printed” document and “paper” document (i.e., document 110), as used interchangeably herein, are intended to encompass any document that may be converted to electronic format using the multifunction device 100. For example, such a document may comprise photocopies, printed-paper, photographs, slides, viewgraphs, color documents, black/white documents, etc. In addition, more than one paper document 110 may be converted to electronic format. For example, one or more pages of the paper document 110 may be imaged using the ADF 101, or individually using the imaging bed 103.

In addition, the term “media” as used herein to refer to presentation media 300, 310 and electronic media (or media in electronic format) 305, 315, is intended to encompass any suitable media for conveying or enhancing the conveyance of information. The media may comprise display media (e.g., text, video, graphics, etc.), audio media (e.g., voice, sound, music, etc.), etc.

Furthermore, the term “multimedia”, as used herein to refer to multimedia presentation 120, is intended to encompass any number of suitable media for conveying or enhancing the conveyance of information. Although the multimedia presentation 120 preferably comprises at least two different media, the multimedia presentation 120 may also comprise like media. For example, the multimedia presentation 120 may comprise a single text document (i.e., one visual media), a voice message and music (i.e., two audio media). In addition, while the multimedia presentation 120 may comprise at least two different media, the recipient need not be presented both types of media. That is, the recipient may be presented with only one of the at least two different media. For example, where a multimedia presentation 120 is sent to a recipient at a fax machine, the recipient may only be presented the visual media.

Continuing now with a more detailed description of the invention, the multifunction device 100 is preferably enabled for connection to a Transmission Control Protocol/Internet Protocol (TCP/IP) network 130. However, the multifunction device 100 may be connected over any suitable network or networks, including but not limited to, a local area network (LAN), a wide area network (WAN), a secure network, an Intranet, the Internet, a telephone network, a combination thereof, etc. Likewise, the multifunction device 100 may be linked to the network 130 in any suitable manner, including but not limited to a hardwired connection, an infrared connection, via satellite, via dial-up connection (i.e., using a modem), a dedicated connection (e.g., cable, digital subscriber line (DSL), T-1, T-3), etc.

In one preferred embodiment, the multifunction device 100 is an HP DIGITAL SENDER™ 9100C (Hewlett Packard Company, Palo Alto, Calif.). The HP DIGITAL SENDER™ 9100C is enabled for sending documents to Internet email accounts, fax machines, to PCs (e.g., for viewing or editing with suitable software applications), to a network folder, and to HP JETSEND®-enabled devices. In another embodiment, the multifunction device 100 may comprise a multifunction peripheral (MFP), such as the HP OFFICE JET® G95 available from Hewlett-Packard Company. The HP OFFICE JET® G95 is enabled for printing, copying, faxing, and scanning documents. However, it is understood that any suitable multifunction device, now known or later developed, may be used according to the teachings of the embodiments of the invention. Indeed, it is understood that in other embodiments, the multifunction device 100 may be another multifunction device or multifunction peripheral, a network digital copier, an “all-in-one” device for attachment to a PC, a document management machine, a network-capable scanner, etc. Regardless of the specific embodiment of the multifunction device 100 that is used, it is understood that one skilled in the art may modify the multifunction device 100, when required, to include suitable media connections (e.g., an audio/visual (AV) jack, infrared link, firewire, universal serial port (USB), etc.) for linking the transducer(s) thereto. Accordingly, the present invention should not be regarded as limited to use with the particular multifunction device 100 shown and described herein.

The multifunction device 100 is preferably provided with a number of transducers operatively associated therewith. For example, an audio transducer may be provided for converting between sound and an electronic audio format thereof. Also for example, a visual transducer may be provided for converting between visual media and an electronic visual format thereof.

The audio transducer may comprise a microphone 150 for converting sound to electronic audio format, and/or a speaker 160 for converting electronic audio format to sound. It is understood that the audio transducer may comprise any suitable device or devices. In one exemplary embodiment, the audio transducer may comprise a microphone and/or speaker that is “built-in” to the multifunction device 100. In another exemplary embodiment, the audio transducer may comprise a microphone and/or speaker otherwise linked to the multifunction device 100 over links 155, 165. In addition, the sound or audio media may comprise any suitable sound such as voice, music, machine-generated sound, etc. Likewise, it is understood that the electronic audio format thereof may comprise any suitable electronic media, such as an electrical signal or frequency, computer readable data (e.g., an MP3 file), etc.

The visual transducer may comprise any suitable imaging device, such as a printer, a scanner, an electronic display 105, camera, camcorder, and/or the like. In one exemplary embodiment, the visual transducer may comprise a display 105 (e.g., a liquid crystal display (LCD), PC monitor, television (TV), etc.). In another exemplary embodiment, the visual transducer may comprise a scanning device (e.g., a copier, a handheld or flatbed PC scanner, a scanner equipped with an ADF, etc.). It is understood that the visual transducer may be “built-in”, directly linked or attached, and/or otherwise linked over a suitable network to the multifunction device 100. It is understood that the visual media may comprise any suitable visual media, such as text, graphics (e.g., icons, illustrations), still-pictures, video, etc. Likewise, it is also understood that the electronic visual format thereof may comprise any suitable electronic media, such as an electrical signal or frequency, computer readable data (e.g., an MPEG file, JPEG file), etc.

Although the invention is illustrated herein with respect to specific types of media, it is not intended that the scope of the invention be limited thereto. Nor is it intended that the scope of the invention be limited to any specific types of transducers for converting between presentation media and the electronic format thereof. In addition, and as explained above, the scope of the invention is intended to encompass any type and any number of media, and is not to be limited by the type of network destination 140-142. Indeed, the multimedia presentation 120 may be delivered to any of a number of different types of network destinations 140-142, now known or later developed, including for example, an email account 140, a fax machine 141, a network printer, a PC, another multifunction device, a combination thereof, etc.

Suitable program code may be provided for generating a multimedia presentation 120 from the presentation media 300, 310 for delivery thereof to a network destination 140-142 from the multifunction device 100. For example, the user may generate a multimedia presentation 120 using the multifunction device 100 to send to a recipient at one or more of the network destinations 140-142, as described in more detail below with respect to FIG. 3. In addition, suitable program code may also be provided for separating the multimedia presentation 120 into presentation media 300, 310 for delivery thereof to a user at the multifunction device 100. For example, the user may receive a multimedia presentation 120 at the multifunction device 100, which may be delivered to the user by printing and/or displaying the visual media and playing the audio media for the user.

Suitable program code may also be provided for synchronizing the presentation media 300, 310. According to one embodiment for synchronizing the presentation media 300, 310, the audio media may be synchronized so that it corresponds to the visual media during presentation thereof to the recipient of the multimedia presentation 120. For example, the user may annotate individual pages of a document with spoken explanations. Preferably in this example, the spoken explanations are presented to the recipient as the corresponding pages are printed or displayed for the recipient.

Such program code for synchronizing the presentation media 300, 310 may comprise, for example, program code for displaying a page number at the multifunction device 100 corresponding to the page of the document 110 that the sender is transmitting, so that the sender may speak into the microphone 150 and annotate the corresponding page. Alternatively, the sender may press a key (e.g., the “2” on keypad 107) on the multifunction device 100 while speaking into the microphone 150 to annotate the corresponding page (e.g., page 2 in this example). Suitable tags (e.g., computer-readable indicia) may be used to mark the electronic media 305, 315 as corresponding to one another so that when the multimedia presentation 120 is reassembled (e.g., FIG. 3), the two presentation media 300, 310 may be delivered in synchronized form with one another.

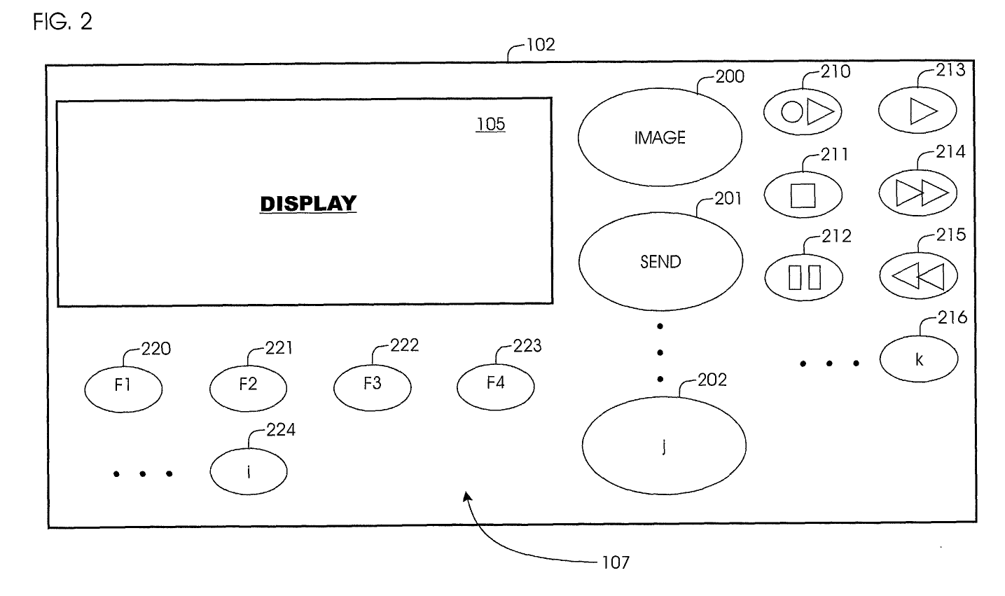

The multifunction device 100 is also preferably provided with an interface 102 operatively associated therewith so that the user may interact with the multifunction device 100 for delivering the multimedia presentation 120. The interface 102 may be “built-in” to the multifunction device 100 (e.g., as shown in FIG. 2), attached or directly linked thereto, and/or otherwise linked over a suitable network to the multifunction device 100. An embodiment of such an interface 102 is shown in more detail in FIG. 2. According to this embodiment, the interface 102 may comprise a display 105 for displaying text (error messages), graphics (e.g., icons), etc. Also according to this embodiment, the interface 102 may comprise a keypad 107 having a plurality of keys 200-202, 210-216, and 220-224 for receiving input from a user of the multifunction device 100.

The keypad 107 may comprise a number of predefined functional keys 200-202. For example, the user may operate an IMAGE key 200 after placing the document 110 in the ADF 101 or on the imaging bed 103 to activate the imaging component of the multifunction device 100. Or for example, the user may operate a SEND key 201 to send the multimedia presentation 120 from the multifunction device 100. Any number of other keys (e.g., KEY j 202) may also be provided for executing predefined functions. Suitable program code is also preferably provided for receiving a signal from the functional key that is operated by the user, and executing functional program code and/or for activating the necessary hardware component(s) for performing the corresponding function.

The keypad 107 may also comprise a number of predefined audio keys 210-216. For example, the user may operate a RECORD key 210 to begin recording audio at the microphone 150. Or for example, the user may operate a PLAY key 213 to begin playing audio from the speaker 160. Other predefined audio keys may also be provided, such as the STOP key 211, the PAUSE key 212, a FAST FORWARD key 214, a REWIND key 215. Any number of other keys (e.g., KEY k 216) may also be provided for various audio functions available to the user at the multifunction device 100. Suitable program code is also preferably provided for receiving a signal from the audio key that is operated by the user, and executing functional program code and/or for activating the necessary hardware component(s) for performing the corresponding function.

The keypad 107 may also comprise a number of other keys 220-224. For example, the user may program any number of functional keys (“F-keys”) for performing various functions (e.g., for recording a macro, displaying a menu, etc.). Also for example, conventional keyboard keys (KEY i 224) may also be provided (e.g., “A”, “1”, “ENTER”, etc.) for the user to interact with the multifunction device 100. Again, suitable program code is also preferably provided for receiving a signal from the key that is operated by the user, and for executing functional program code and/or for activating hardware component(s).

It is understood that the embodiment of the interface 102 shown and described above with respect to FIG. 2 is provided to illustrate various embodiments of the invention. It is not intended that the scope of the invention be limited thereto. In other embodiments, for example, the interface 102 may comprise a graphical user interface (GUI) that is displayed on a PC monitor and receives user input from a PC keyboard and/or PC mouse. Other embodiments of the interface 102 for implementing the teachings of the invention will also become apparent to one skilled in the art, and are contemplated as being within the scope of the invention.

Although the user may interface with the multifunction device 100 for assembling the various components of the multimedia presentation 120, as just described, the multimedia presentation 120 itself is preferably generated automatically and transparently to the user. That is, the user preferably only needs to specify a recipient, position the paper document 110 in the ADF 101 or directly on the flatbed scanner 103, and record an audible sound (e.g., voice, music, etc.) with the microphone 150. The multifunctional peripheral 100, using suitable program code, receives the presentation media 300, 310, converts the presentation media to electronic format 305, 315 for combination with the various other components of the multimedia presentation 120 (e.g., routing information), and sends it to the network destination 140-142, with few, if any, additional steps required by the user.

Preferred embodiments of the multimedia presentation 120 may comprise a header, a message, and one or more attachments. The header preferably identifies routing information for the multimedia presentation 120, such as the recipients, the sender, and any other suitable routing information in any suitable format. The message may be included for conveying additional information to the recipient. Although the message may take any suitable format, it preferably includes instructional text or identifying information, much like that which may be included on a fax cover sheet. The attachment(s) preferably comprise the electronic media 305, 315.

Although according to one preferred embodiment of the invention, the multimedia presentation 120 may be sent as an attachment from the multifunction device 100 to the recipient, other embodiments are also contemplated as being within the scope of the invention. In another such embodiment, for example, the multimedia presentation 120 may be delivered from the multifunction device to a network site (e.g., an Internet site), and a link thereto may be sent to the recipient. Upon receiving the link to the Internet site, the recipient may retrieve or otherwise access (e.g., view via streaming audio/video) the multimedia presentation 120 from the Internet site. This embodiment reduces the volume of data that is sent to the recipient so that the recipient's email server does not reject the multimedia presentation 120. In addition, this embodiment allows for additional security (i.e., the streaming data may only be viewed at predetermined destinations).

In any event, the multimedia presentation 120 is preferably formatted so that it can be converted for output from one or more readily available devices (e.g., another multifunction device, a fax machine, a printer, a photocopier, an audio speaker, a personal computer, etc.). For example, the electronic document image may be formatted for viewing with readily available software (e.g., ADOBE® READER®, an email application, a web browser). Also for example, the electronic audio signal may be formatted for playback through a speaker (e.g., 160).

An embodiment of a method for delivering a multimedia presentation 120 may be illustrated with reference to FIG. 3. According to this embodiment of the method, a first presentation media 300 and a second presentation media 310 are each converted to electronic format (i.e., first electronic media 305 and second electronic media 315, respectively), as illustrated in step 301. For example, the user may speak into the microphone 150 and record his or her voice, and image a document 110 using the imaging bed 103 of the multifunction device 100. The first and second presentation media 300, 310 received at the multifunction device 100 (i.e., in electronic format) may then be used to generate a multimedia presentation 120, as illustrated in step 302. For example, the voice recording may be combined with the image of the document 110, as described in more detail above, to generate the multimedia presentation 120 at the multifunction device. Accordingly, the multifunction device 100 may be used for delivery of a multimedia presentation 120 to a network destination 140-142.

The following illustration is provided as an exemplary use of the multifunction device 100 according to the method for delivering a multimedia presentation 120, as shown and described above with respect to FIG. 3. In this illustration, the user may be an engineer in charge of “pitching” a new product to the corporate sales team (i.e., the recipient(s)). The corporate sales team may require the engineer to provide preliminary diagrams and photographs of the proposed product before they schedule a formal presentation with top sales executives. Although the engineer may simply send the required diagrams and photographs to the corporate sales team using the multifunction device 100, the engineer's proposal may have a greater impact if it is delivered as a multimedia presentation. That is, instead of simply sending “dry” diagrams and photographs to the corporate sales team, the engineer may also want to include voice annotations for the various diagrams and photographs, explaining each in more detail and conveying the engineer's enthusiasm for the product to enhance the preliminary proposal.

According to preferred embodiments of the invention, the engineer may place one or more pages of a printed document 110 (e.g., product diagrams, photographs, etc.) on the imaging bed 103 of the multifunction device 100, wherein it may be electronically imaged and converted to electronic format. In addition, the engineer may speak into the microphone 150 to record voice or spoken explanations of the document 110. Where the spoken explanations pertain to specific pages of the printed document 110, these explanations may even be synchronized (e.g., as previously discussed in more detail) so that the spoken explanations and the specific pages of the printed document 110 correspond to one another. In any event, the first electronic media 305 (i.e., the voice recording), and the second electronic media 315 (i.e., the electronically imaged document) may be combined to generate the multimedia presentation 120 for delivery to the recipient (i.e., the corporate sales team) at one or more network destinations 140-142 from the multifunction device 100.

Another embodiment of a method for delivering a multimedia presentation 120 may be illustrated with reference to FIG. 4. According to this embodiment of the method, a multimedia presentation 120 may be received at the multifunction device 100. The multimedia presentation 120 may be separated into a first presentation media 300 and a second presentation media 310, as illustrated in step 401. For example, the multimedia presentation 120 may be separated into a voice recording and an electronic image of a document 110. Accordingly, the multimedia presentation may be delivered to a user at the multifunction device 100, as illustrated in step 402. For example, the voice recording may be played for the recipient through the audio speaker 160, and the document 110 may be printed for the recipient at the multifunction device 100 or a printer operatively associated therewith.

The following illustration is provided as an exemplary use of the multifunction device 100 according to the method for delivering a multimedia presentation 120, as shown and described above with respect to FIG. 4. In this illustration, the recipient may be a member of the corporate sales team who also has a multifunction device 100 for receiving the multimedia presentation 120 that was assembled and delivered by the engineer, as in the previous illustration of FIG. 3. According to preferred embodiments of the invention, the multimedia presentation 120 is received at the multifunction device 100 and separated into individual media 305, 315. In this example, the multimedia presentation 120 is separated into the image of the document 110 (e.g., product diagrams, photographs, etc.) and the voice recording (e.g., the engineer's spoken explanations of the document 110). Where the spoken explanations were synchronized with specific pages of the printed document 110, these explanations are preferably so synchronized for delivery to the recipient. In any event, the first electronic media 305 (i.e., the voice recording) may be played for the recipient through the speaker 160, and the second electronic media 315 (i.e., the electronically imaged document) may be printed from the multifunction device 100 or a printer operatively associated therewith.

It is understood that the embodiments of the method shown and described in FIG. 3 and FIG. 4, and the examples and illustrations given with respect thereto, are merely illustrative of methods for delivering multimedia presentations according to the teachings of the invention. However, other embodiments of the method are also contemplated as being within the scope of the invention. Other embodiments may comprise modifications to the steps shown and/or described above. Still other embodiments may comprise additional steps. In addition, the steps shown and/or described above need not be performed in any given order. For example, various steps may be performed before, after, or simultaneously with one another. Furthermore, it is understood that the same steps may be performed in more than one manner according to various embodiments of the invention.

What is claimed is:

1. A multimedia delivery method, comprising:
receiving a first presentation media and a second presentation media at a multifunction device;
converting at least one of said presentation media by the multifunction device from paper format to electronic format;
generating a multimedia presentation in electronic format from said received first and second presentation media for delivery thereof to a network destination from said multifunction device.

2. The method of claim 1, further comprising sending said multimedia presentation from said multifunction device to said network destination.

3. The method of claim 1, further comprising converting each of said presentation media to electronic format at said multifunction device.

4. The method of claim 1, further comprising prerecording said multimedia presentation for later delivery thereof.

5. The method of claim 1, further comprising converting at least one of said presentation media from sound to electronic format.

6. The method of claim 1, further comprising synchronizing said first presentation media and said second presentation media.

7. The method of claim 1, further comprising annotating said first presentation media with said second presentation media.

8. A multimedia delivery method, comprising:
receiving a multimedia presentation at a multifunction device; and
separating said multimedia presentation into a first presentation media and a second presentation media for delivery thereof to a user at said multifunction device.

9. The method of claim 8, further comprising displaying said first presentation media.

10. The method of claim 8, further comprising printing said first presentation media.

11. The method of claim 8, further comprising generating sound from said second presentation media.

12. The method of claim 8, further comprising annotating said first presentation media with said second presentation media.

13. The method of claim 8, further comprising synchronizing said first presentation media and said second presentation media.

14. A multifunction device for delivering a multimedia presentation, comprising:
a first transducer for formatting a first presentation media;
a second transducer for formatting a second presentation media;
computer readable media operatively associated with said multifunction device and having computer readable program code thereon including:
program code for generating a multimedia presentation from said first and second presentation media for delivery thereof to a network destination from said multifunction device; and
program code for separating said multimedia presentation into said first and second presentation media for delivery thereof to a user at said multifunction device.

15. The multifunction device of claim 14, further comprising an interface operatively associated with said computer readable program code for interfacing with said user of said multifunction device.

16. The multifunction device of claim 14, wherein said computer readable program code further includes program code for sending said multimedia presentation from said multifunction device to said network destination.

17. The multifunction device of claim 14, wherein said computer readable program code further includes program code for receiving said multimedia presentation at said multifunction device.

18. The multifunction device of claim 14, wherein said computer readable program code further includes program code for synchronizing said first presentation media and said second presentation media.

19. The multifunction device of claim 14, wherein said first transducer comprises an audio transducer.

20. The multifunction device of claim 14, wherein said second transducer comprises an imaging component operatively associated with said multifunction device.
